(19) United States
(12) Patent Application Publication
(10) Pub. No.: US 2026/0340595 A1
(43) Pub. Date: Oct. 29, 2026

(54) MOTHERBOARD CREDENTIAL AND VOUCHER CREATION FOR DEVICE ONBOARDING

(71) Applicant: Dell Products L.P., Round Rock, TX (US)

(72) Inventors: Eric Bruno, Shirley, NY (US); Mahesh Babu Ramaiah, Bangalore (IN); Ravinder Tamishetty, Singapore (SG); Xingyu Wang, Singapore (SG)

(73) Assignee: Dell Products L.P., Round Rock, TX (US)

(21) Appl. No.: 19/189,428

(22) Filed: Apr. 25, 2025

(51) Int. Cl. G06Q 10/20

(52) U.S. Cl. CPC G06Q 10/20

(57) ABSTRACT

A system and method are disclosed for late-binding a device serial number or service tag to a motherboard voucher using voucher extension, thereby securely associating a customer device with a replacement motherboard. In an embodiment, a method comprises receiving a request to replace a first motherboard in a device and designating a second motherboard to replace the first motherboard. The first motherboard has a first serial number, the second motherboard having a second serial number, and the device has a service tag and a first ownership voucher. A voucher management system links the second identifier to the service tag and identifies the second ownership voucher using the second identifier. The second ownership voucher is extended with information from the first ownership voucher, and the extended second ownership voucher is linked to the first ownership voucher.

### BACKGROUND

As the value and use of information continues to increase, individuals and businesses seek additional ways to process and store information. One option is an Information Handling System (IHS). An IHS generally processes, compiles, stores, or communicates information or data for business, personal, or other purposes. Technology and information handling needs and requirements can vary between different applications. Thus, IHSs can also vary regarding what information is handled, how the information is handled, how much information is processed, stored, or communicated, and how quickly and efficiently the information can be processed, stored, or communicated. The variations in IHSs allow systems to be general or configured for a specific user or specific use such as financial transaction processing, airline reservations, enterprise data storage, internet of things (IOT) monitoring and communications, or global communications. In addition, IHSs can include a variety of hardware and software resources that can be configured to process, store, and communicate information and can include one or more computer systems, graphics interface systems, data storage systems, and networking systems. IHSs can also implement various virtualized architectures. Data communications among information handling systems may be via networks that are wired, wireless, optical or some combination. IHSs can be used in a distributed environment as edge devices. Example edge devices include applications running in a retail store, such as point of sale device, a gateway, a compute or storage device not operating in a datacenter, remote industrial sensor and monitoring equipment, or deployed telecommunications equipment.

### SUMMARY

Embodiments are directed to a method to late-bind a device serial number or service tag to a motherboard voucher using voucher extension, thereby securely associating a customer device with a replacement motherboard. This achieves security in the motherboard replacement process by placing the root of trust in the motherboard factory. The motherboards are manufactured with a voucher and associated device attestation key in controlled, secure environment. This eliminates the usage of quarantine keys for the control plane connection to re-onboard repaired devices (i.e. new motherboard) when repaired on site.

The history of motherboard replacement activity is securely tracked in the device voucher and in both a control plane and a voucher management service. The signed vouchers are tamper evident, thereby assuring the accuracy of the ownership history records.

The process disclosed herein supports replacement of both the motherboard and the boot drive simultaneously, which allows for multi-part replacement for re-onboarding a device. If only the motherboard is replaced, the operating system will detect the motherboard replacement on boot due to new serial number and will switch the boot partition back to a factory operating system for rebooting. The device will then proceed to the normal onboarding process with the device credentials and ownership voucher for the new motherboard. If the motherboard and the boot drive are both replaced, the factory operating system is restored onto the new drive (e.g., via a factory reset generated by the control plane). The device will then boot the factory operating system and proceed to the normal onboarding process with the new motherboard’s device credentials and new voucher.

This method includes built-in protection against incorrect or counterfeit motherboard replacement by a nefarious actor or human error. Only motherboards with factory device credentials will match the signed voucher that comes from the original motherboard manufacturer via the control plane and voucher management system, and those motherboards will be onboarded to the control plane only if the credentials indeed match.

The method defines a secure transaction for motherboard replacement that ensures the device is eligible for secure motherboard replacement only when in the right state (i.e., properly onboarded by its rightful owner) and only by its rightful owner.

### BRIEF DESCRIPTION OF THE DRAWINGS

Having thus described the invention in general terms, reference will now be made to the accompanying drawings, which are not necessarily drawn to scale, and wherein:

FIG. 1 is a high level block diagram illustrating a process 100 for onboarding a device at a customer location using FDO.

FIG. 2 illustrates a secure method for replacement of motherboards on onboarded devices at customer sites.

FIG. 3 illustrates the replacement voucher chain.

FIG. 4 illustrates a secure transaction timeline according to an example embodiment.

FIG. 5 shows an example of an Information Handling System (IHS) configured to implement systems and methods as described herein for upload of motherboard replacement vouchers for an air-gapped voucher service.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

The Fast IDentity Online (FIDO) Alliance has promulgated a set of security-focused technologies and protocols intended to simplify and enhance cybersecurity. Information handling systems, such as server devices and/or other computing devices, may benefit by performing authentication via the FIDO Device Onboarding (FDO) protocol, particularly when provided at the “edge” of a network (“edge devices”). FDO is a system of zero-touch secure onboarding that is designed to have endpoint devices securely and automatically determine who their proper owner is, and then connect, onboard to, and be operated by said owner; without this being configured or even determined at manufacturing time.

Late Binding: FDO and similar systems of zero-touch, secure onboarding allow devices to be late-bound. This means the devices can be built with no knowledge of who a final owner will be or even the type of software or operating system that the device will run. Thus, a “generic” device can be built in manufacturing and then shipped to the customer or stocked in a warehouse for a future customer. After purchase and installation, the device’s final, intended owner is determined. The final owner also decides what software should run on the device and how the device will be configured and credentialed so that it can be accessed and managed by the customer and/or upstream control systems. Zero-touch onboarding systems provide a means for all of this to happen automatically, meaning that onboarding can occur with “zero-touch” and without any user intervention. The onboarding is also secure, which allows onboarding to be stated and done in a provable manner. Zero-touch Secure onboarding allows the final disposition of a device to be both post-manufacture and in a strong, provable manner.

During device manufacture, the FDO Device Initialization (DI) process generates device credentials and an ownership voucher. The device credentials are securely placed on the Trusted Platform Module (TPM) on the device’s motherboard. Later, a dedicated control plane can use the voucher to form a secured communication channel with the device. The device credentials and voucher are usually generated during the device assembly manufacturing; however, this raises issues for motherboard replacement. Motherboard manufacture usually takes place before device assembly in a different factory. This means the replacement motherboards are without keys that can be used to form a secured communication channel with the control plane. Because servicing sites for motherboard replacement typically are not the strict controlled environment as found in a factory, this requires to use some quarantine credentials to secure new device credentials and for a voucher generation process. Since the TPM is usually mounted on the motherboard, this quarantine credential can only be saved on the device’s hard drive, which has a much lower level of security. The process described herein provides a way to move the DI process from the final device assembly step to the motherboard manufacturing step, which provides a simple but more secure way for motherboard replacement.

Embodiments are directed to manufacturing motherboards with the secrets already installed and an associated voucher. When the motherboard is replaced, the new motherboard has an associated voucher and already contains the required device credentials. After motherboard replacement, the new motherboard voucher and credentials have to be associated with the original ownership voucher.

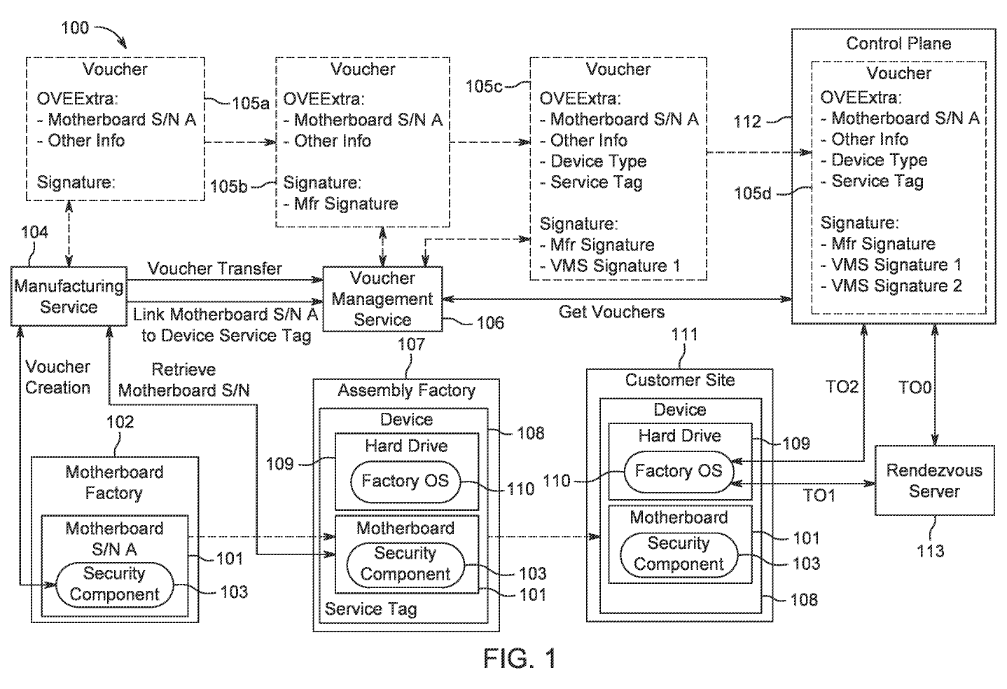

FIG. 1 is a high level block diagram illustrating a process 100 for onboarding a device at a customer location using FDO. A motherboard 101 is manufactured at a motherboard factory 102. The motherboard 101 has a security component 103, such as a TPM or a Replay Protected Memory Block in an Integrated Dell Remote Access Controller (iDRAC) from Dell Inc. Device credentials for motherboard 101 are saved in the security component 103. A manufacturing service 104 having a manufacturing key generates an ownership voucher 105a through the DI process. FDO defines a mechanism called OVEExtra that permits information from the supply chain to be added to voucher 105a. This information includes a motherboard serial number (S/N) “A” that securely bonds the voucher 105a to the motherboard 101. The manufacturing service 104 signs the voucher 105a to a central voucher management system (VMS) 106 as voucher 105b.

The motherboard 101 is sent to an assembly factory 107 where it is incorporated into a device 108. Device 108 includes additional components, such as a hard drive 109 with a factory operating system (OS) 110 installed. During the assembly process, manufacturing service 104 retrieves the motherboard serial number and assigns a service tag to device 108. The service tag is a unique identifier for device 108, such as a Globally Unique Identifier (GUID). The manufacturing service 104 links the motherboard serial number to the service tag of the new device 108 and sends a message to voucher management service 106 with this information (i.e., mapping motherboard serial number to service tag).

The voucher management service 106 uses the motherboard serial number A to find the voucher 105b for motherboard 101. Voucher management service 106 extends voucher 105b by adding the service tag and a signature (VMS Signature 1) to create voucher extension 105c.

After device 108 has been assembled, it is shipped to a customer site 111 where a new owner will begin device onboarding. A customer control plane 112 periodically checks with the voucher management service 106 to determine if new ownership vouchers are available. Voucher management service 106 transfers extended voucher 105c to control plane 112 as voucher 105d with another signing (VMS Signature 2). Control plane 112 then registers voucher 105d to rendezvous server 113 using FDO Transfer Ownership (TO) protocols. When device 108 first boots up, it contacts the rendezvous server 113 to be redirected to control plane 112, which finally onboards device 108 to control plane 112 using the TO protocols.

FIG. 1 illustrates a process for late binding of the motherboard 101 to the device 108. Existing create the device credentials and voucher when the motherboard is assembled into the device. In this process disclosed herein, the voucher and the credentials are created before the motherboard is ever coupled to the device. This requires late binding of the motherboard - with its voucher and credentials – to the device itself, which does not occur in existing manufacturing processes. This leads to a more secure replacement in the future if the motherboard needs to be replaced in the existing device after onboarding.

During the lifetime of the onboarded device 108, the motherboard 101 may be replaced if it fails. However, since the device attestation key (DAK) associated with the ownership voucher is secured in the motherboard TPM or security component 103, that association is lost when the motherboard 101 is replaced. As a result, if a replacement motherboard has no device credentials and is not associated with an ownership voucher, a new voucher and device credentials (including DAK) must be created at the customer site when the motherboard is replaced. This process is insecure and does not provide supply chain assurance regarding device ownership.

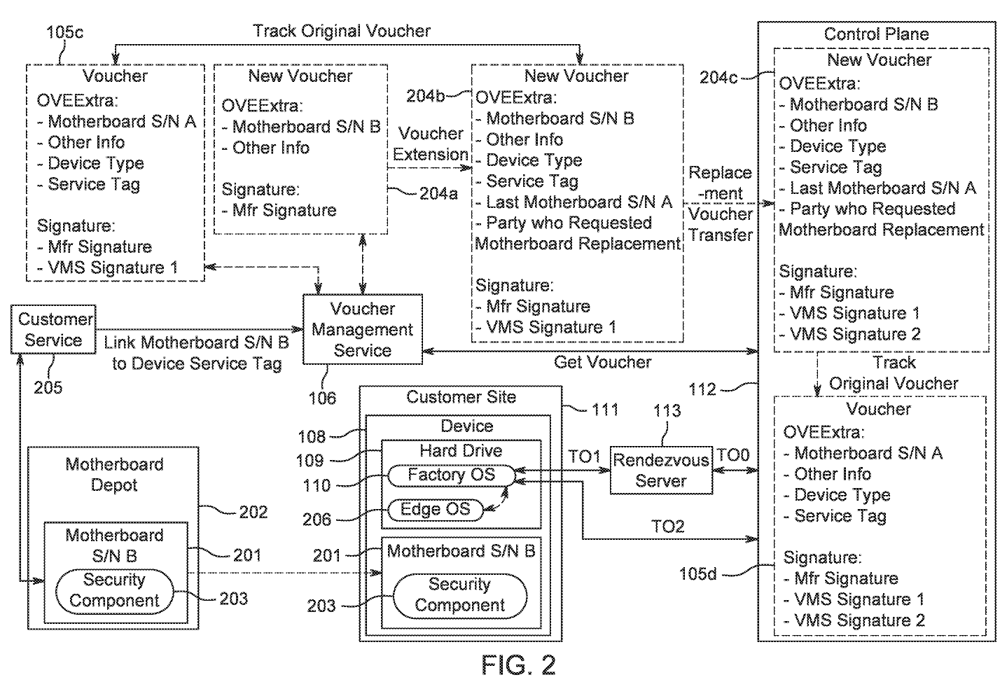

FIG. 2 illustrates a secure method that uses motherboards that are created with a DAK and voucher upon manufacture. This includes motherboards used for replacement of onboarded devices at customer sites. A motherboard 201 is stored in inventory at a motherboard depot 202, such as a distributor warehouse or motherboard factory 102. Motherboard 201 has an assigned serial number “B.” Motherboard 201 has a security component 203, such as a TPM or iDrac. Credentials for motherboard 201 are saved in the security component 203. Motherboard 201 has already been through the DI process with a manufacturing service 104 that generated an ownership voucher 204a. The new voucher 204a for motherboard 201 has been uploaded to voucher management service 106.

Motherboard replacement in a deployed device 108 takes place in three stages. In the first stage, customer service 205 receives a request for motherboard replacement for device 101 and assigns replacement motherboard 203 with serial number B. Customer service 205 then sends a request to voucher management service 106 to link motherboard serial number B to the service tag associated with device 108. Since this is a motherboard replacement request, the request also contains the original motherboard 101 serial number A and some identifier that identifies the customer who requested the replacement.

Voucher management service 106 find the new voucher 204a in its database with motherboard serial number B. Voucher management service 106 extends new voucher 204a with the following: device type, service tag, the last motherboard serial number A, an identifier for the party who requested motherboard replacement (e.g., the customer), and VMS Signature 1 to create extended new voucher 204b. Voucher management service 106 also links extended new voucher 204b to the original voucher with motherboard serial number A for tracking purposes. So, if the customer wants to resell device 108, the next party who receives this device 108 will also be able to see in this extended new voucher 204b who was the previous owner who did the motherboard replacement.

In the second stage, the new voucher is transferred to the control plane 112. Control plane 112 periodically checks voucher management service 106 to see if new vouchers are ready. When a new voucher is available, voucher management service 106 signs the voucher again (VMS Signature 2) and transfers it to control plane 112 as new voucher 204c. Control plane 112 identifies the new voucher 204c as a replacement voucher because it contains the previous motherboard serial number (Serial Number A). So, control plane 112 links the new replacement voucher 204c to the original voucher 105d for tracking. Additionally, the control plane 112 registers (TO0) the new voucher 204c with the rendezvous server 113 along with the control plane onboarding service address and protocol information for device onboarding.

The third stage is actual motherboard replacement. Servicing personnel conduct the replacement at the customer site 111 and install new motherboard 201 in device 108. Once the motherboard is replaced and device 108 is powered on, the device will boot to an Edge OS 206, which is the day-two operating system (i.e., a post-onboarding OS) in use once device 108 was initially onboarded to control plane 112. During system boot, the Edge OS 206 identifies that the serial number on the motherboard has changed from the previous record, which will cause device 108 to reboot to Factory OS 110.

The Factory OS 110 identifies that device 108 has a new motherboard 201, and it starts to re-onboard the device. It first contacts (TO1) the rendezvous server 113 for redirection to the control plane 112. Then, Factory OS 110 contacts (TO2) control plane 112 during which the mTLS (mutually-authenticated Transport Layer Security) keys will be regenerated for Edge OS 206 to establish a secure communication channel with control plane 112. Once device 108 with new motherboard 203 is re-onboarded to control plane 112, it will transfer back to Edge OS 206 for normal day-two activities, which completes the FIDO onboarding.

After TO2, Factory OS 110 will not reinstall Edge OS 206 as in normal onboarding, but instead will reboot to the original Edge OS 206 as a shortcut in the onboarding process. In the Edge OS 206, device 108 can connect with control plane 112 with the previously established mTLS keys. Next, device 108 will securely complete other restoration steps, such as storage key restoration, and the rest of the motherboard replacement process. After this automated process completes successfully, device 108 will be securely onboarded, provisioned, and will be fully operational. Using the process outlined above the Edge OS 206 is there after the onboarding occurs and trust has been reestablished with the control plane, which allows device 108 to boot into the existing Edge OS 206 and device 108 is restored as though the motherboard replacement never happened.

It is preferable to restore device 108 back to its working order if the Edge OS 206 is still loaded. However, in an alternative arrangement, the customer may have to replace the motherboard 101 and the hard drive 109 at the same time. In this situation, the Factory OS 110 is installed on the new motherboard 201. Factory OS 110 will re-onboard device 108 and then download a new copy of Edge OS 206 into a new hard drive as though device 108 was a new machine (i.e., normal onboarding). While this results in the loss of the original edge OS, the device 108 is still able to get back to working order. This allows for replacement of the motherboard and the hard drive at the same time, which is not possible in existing methods.

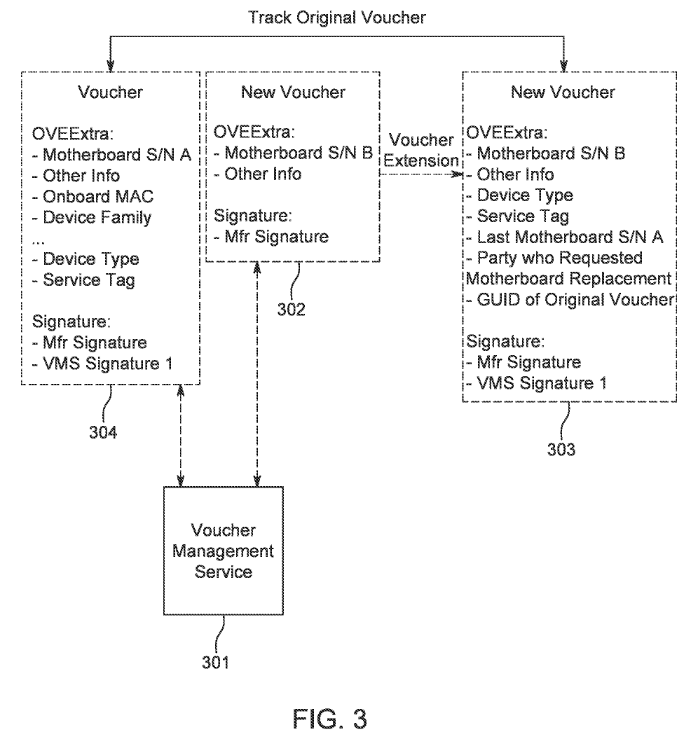

FIG. 3 illustrates the replacement voucher chain. The motherboard replacement process includes a secure voucher chain for tracking a replacement motherboard secure transaction to guarantee the integrity of the voucher chain. For tracking purposes, when the voucher management service 301 receives a request to extend new voucher 302 for the new motherboard, it will also link the extended new voucher 303 with the voucher 304 for the original motherboard. The link between vouchers can be tracked in a database in voucher management service 301. Additionally, the GUID of the original voucher 304 can be included in the extended new voucher 303. Because both the replacement voucher 303 and the original voucher 304 are signed by the voucher management service key, the control plane can validate the GUID and the signature to confirm that the voucher with motherboard serial number A is in fact the original voucher of the device with the replacement motherboard.

A potential issue arises where two requests to repair the same motherboard are received, such as when two users call about the same customer site. This can create a situation where two motherboard replacements are in process at the same time. This would result in the original voucher being extended in two different ways – first to replacement motherboard “B,” as described above, and then to a second replacement motherboard “C.” This situation can be avoided by employing the idea of a secure transaction wherein there are valid times for a motherboard replacement and invalid times to initiate a replacement.

The secure transaction begins when a replacement motherboard is ordered by the customer providing the applicable device’s service tag, customer information, and customer credentials. The secure transaction ends when the replacement voucher is transferred to the customer control plane and the device has connected to the control plane. After the secure transaction period, the device is available for new motherboard replacement requests. However, any additional requests within the secure transaction time frame will be rejected. This ensures that only one replacement motherboard with a voucher will be associated with, and dispatched for, a particular device in the defined time frame, thereby guaranteeing the voucher chain integrity.

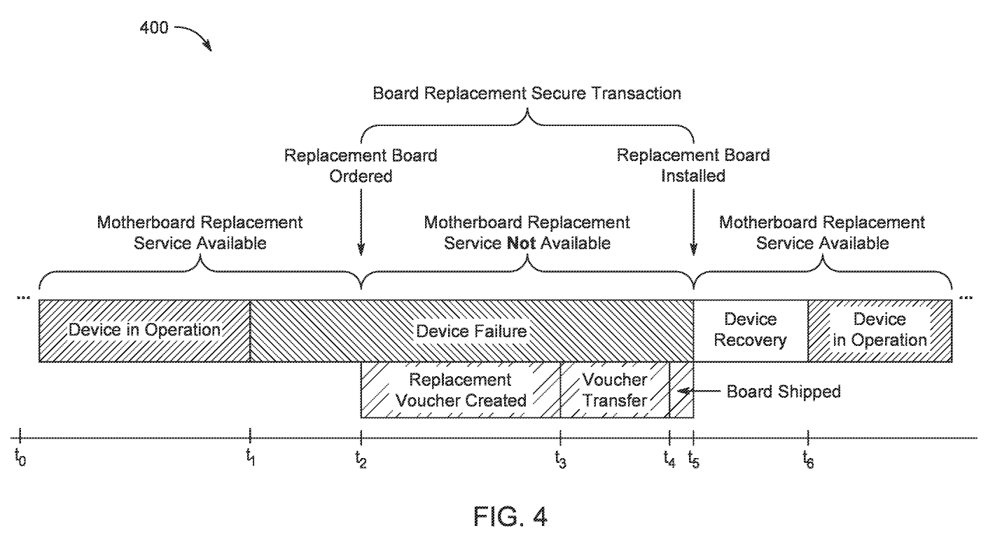

FIG. 4 illustrates a secure transaction timeline according to an example embodiment. A device is put into operations and onboarded at time t0. The device continues operating until time t₁ when there is a failure that requires motherboard replacement. Accordingly, the device goes out of service at time t₁. Eventually, the customer will recognize the device failure and will request a replacement motherboard at time t₂. As discussed above, a customer service will link a new motherboard serial number to a device service tag, and then the voucher management service will create a new voucher.

At time t₃, the new voucher is transferred to the customer’s control plane. At time t₄, the replacement motherboard is shipped to the customer site. The replacement motherboard is installed in the device at time t₅, and the device begins to recover, such as re-onboarding to the control plane. At time t₆, the device has recovered and begins normal operations again.

The period from when the replacement motherboard is ordered at t₂ until the replacement motherboard is installed at t₅ is the secure transaction window. During that period, the motherboard replacement service is not available, which prevents two or more motherboard replacement vouchers being created for the device at the same time. The voucher management service and/or the customer service can enforce the secure transaction window as long as either one receives information that a replacement motherboard was ordered and that the replacement motherboard has been installed. The voucher management service knows when a replacement motherboard is ordered because the replacement voucher is created. The control plane can provide feedback to the customer service and/or voucher management service when the repaired device has re-onboarded after motherboard replacement.

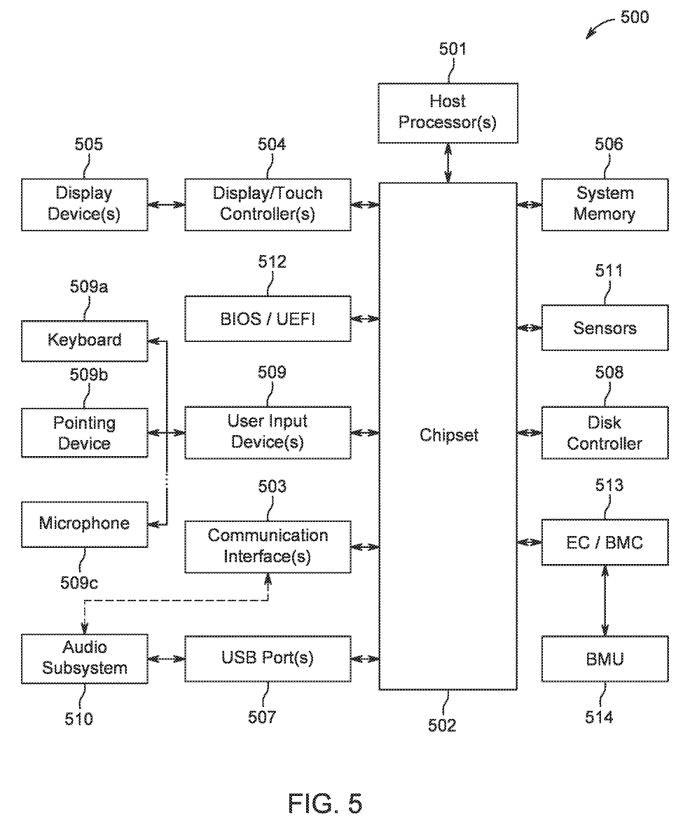

FIG. 5 shows an example of an Information Handling System (IHS) 500 configured to implement systems and methods as described herein for upload of motherboard replacement vouchers for an air-gapped voucher service. IHS 500 may be used as a device 108 or as a host for a control plane 103, voucher service 106, rendezvous server 113, or customer service 205. Users may use an IHS 500 to access the control plane 103 or voucher service 106.

As depicted, IHS 500 includes host processor(s) 501. In various embodiments, IHS 500 may be a single-processor system, or a multi-processor system including two or more processors. Host processor(s) 501 may include any processor capable of executing program instructions, such as an INTEL/AMD x76 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 500 includes chipset 502 coupled to host processor(s) 501. Chipset 502 may provide host processor(s) 501 with access to resources. In some cases, chipset 502 may utilize a QuickPath Interconnect (QPI) bus to communicate with host processor(s) 501. Chipset 502 may also be coupled to communication interface(s) 503 to enable communications between IHS 500 and various wired and/or wireless networks, such as Ethernet, WiFi (IEEE 802.11), Bluetooth (IEEE 802.15.1), cellular or mobile networks (e.g., Code-Division Multiple Access or “CDMA,” Time-Division Multiple Access or “TDMA,” Long-Term Evolution or “LTE,” etc.), satellite networks, or the like. Communication interface(s) 503 may be used to communicate with peripheral devices (e.g., Bluetooth speakers, microphones, headsets, etc.). Moreover, communication interface(s) 503 may be coupled to chipset 502 via a Peripheral Component Interconnect Express (PCIe) bus, or the like.

Chipset 502 may be coupled to display and/or touchscreen controller(s) 504, which may include one or more Graphics Processor Units (GPUs) on a graphics bus, such as an Accelerated Graphics Port (AGP) or PCIe bus. As shown, display controller(s) 504 provide video or display signals to one or more display device(s) 505. Display device(s) 505 may include Liquid Crystal Display (LCD), Light Emitting Diode (LED), Organic LED (OLED), or other thin film display technologies. Display device(s) 505 may include a plurality of pixels arranged in a matrix, configured to display visual information, such as text, two-dimensional images, video, three-dimensional images, etc. In some cases, display device(s) 505 may be provided as a single continuous display, rather than two discrete displays.

Chipset 502 may provide host processor(s) 501 and/or display controller(s) 504 with access to system memory 506. In various embodiments, system memory 506 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 502 may also provide host processor(s) 501 with access to one or more Universal Serial Bus (USB) ports/controllers 507, to which one or more peripheral devices may be coupled (e.g., integrated or external webcams, microphones, speakers, etc.).

Chipset 502 may further provide host processor(s) 501 with access to a disk controller 508, which may include a disk interface that connects the disc controller 508 to a Hard Disk Drive (HDD), an Optical Disk Drive (ODD), an SSD, and/or a disk emulator. The disk interface may include, for example, an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. The disk emulator may be provide an external interface that permits one or more hard disk drives, solid-state drives, optical drives, or other removable-media drives to be connected to IHS 500. An example of external interface includes a USB interface, an IEEE 1394 (Firewire) interface, a proprietary interface, or a combination thereof.

Chipset 502 may also provide access to one or more user input devices 509, for example, using a super I/O controller or the like. Examples of user input devices 509 include, but are not limited to, a keyboard 509a, pointing device 509b, such as a mouse, trackball, stylus, or active pen, and/or microphone(s) 509c. Other user input devices 509 (not shown) may include a camera, touchpad, totem, etc. Each user input device 509 may include a respective controller (e.g., a touchpad may have its own touchpad controller) that interfaces with chipset 502 through a wired or wireless connection, for example via communication interfaces(s) 503 and/or USB port(s) 507. Other input devices, such as keyboard 509a, may use a keyboard controller in an operating system.

In some cases, chipset 502 may also provide access to one or more output devices, such as an audio subsystem 510, speakers, headsets, video projectors, paper printers, 3D printers, Virtual/Augmented Reality (VR/AR) devices, etc. The output devices may be accessed, for example, via communication interfaces(s) 503 and/or USB port(s) 507. Audio subsystem 510 may include speakers, which comprise any system, device, or apparatus configured to produce sound in response to electrical audio signal input. In some embodiments, a speaker may comprise a dynamic loudspeaker, which employs a lightweight diaphragm mechanically coupled to a rigid frame via a flexible suspension that constrains a voice coil to move axially through a cylindrical magnetic gap such that when an electrical signal is applied to the voice coil, a magnetic field is created by the electric current in the voice coil, making it a variable electromagnet. The coil and the driver's magnetic system interact, generating a mechanical force that causes the coil (and thus, the attached cone) to move back and forth, thereby reproducing sound under the control of the applied electrical signal coming from the amplifier.

In certain embodiments, chipset 502 may further provide an interface for communications with one or more hardware sensors 511. Sensors 511 may be disposed on or within the chassis of IHS 500, or otherwise coupled to IHS 500, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

A Basic Input and Output System/Unified Extensible Firmware Interface (BIOS/UEFI) 512 is coupled to chipset 502. UEFI was designed as a successor to BIOS, and many modern IHSs utilize UEFI in addition to or instead of a BIOS. Accordingly, BIOS/UEFI 512 is intended to also encompass a UEFI component. BIOS/UEFI 512 provides an abstraction layer that allows the OS to interface with certain hardware components that are utilized by IHS 500. Upon booting of IHS 500, host processor(s) 501 may utilize program instructions of BIOS 512 to initialize and test hardware components coupled to IHS 500, and to load a host OS for use by IHS 500. Via the hardware abstraction layer provided by BIOS/UEFI 512, software stored in system memory 506 and executed by host processor(s) 501 can interface with I/O devices coupled to IHS 500.

An Embedded Controller (EC) 513 (sometimes referred to as a Baseboard Management Controller or “BMC”) includes a microcontroller unit or processing core dedicated to handling selected IHS operations not ordinarily handled by host processor(s) 501. Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes (LEDs) (e.g., caps lock, scroll lock, num lock, battery, ac, power, wireless LAN, sleep, etc.), managing the battery charger and the battery, enabling remote or Out-of-Band (OOB) management, diagnostics, and remediation over network(s), and the like.

Unlike other devices in IHS 500, EC 513 may be made operational from the very start of each power reset, before other devices are fully running or powered on. As such, EC 513 may be responsible for interfacing with a power adapter to manage the power consumption of IHS 500. These operations may be utilized to determine the power status of IHS 500, such as whether IHS 500 is operating from battery power or is plugged into an AC power source. Firmware instructions utilized by EC 513 may be used to manage other core operations of IHS 500 (e.g., turbo modes, maximum operating clock frequencies of certain components, etc.).

In some cases, EC 513 may implement operations for detecting certain changes to the physical configuration or posture of IHS 500 and managing other devices in different configurations of IHS 500. For instance, when IHS 500 as a 2-in-1 laptop/tablet form factor, EC 513 may receive inputs from a lid position or hinge angle sensor 511, and it may use those inputs to determine: whether the two sides of IHS 500 have been latched together to a closed position or a tablet position, the magnitude of a hinge or lid angle, etc. In response to these changes, the EC may enable or disable certain features of IHS 500 (e.g., front or rear facing camera, etc.).

In some implementations, EC 513 may be installed as a Trusted Execution Environment (TEE) component to the motherboard of IHS 500. Additionally, or alternatively, EC 513 may be further configured to calculate hashes or signatures that uniquely identify individual components of IHS 500. In such scenarios, EC 513 may calculate a hash value based on the configuration of a hardware and/or software component coupled to IHS 500. For instance, EC 513 may calculate a hash value based on all firmware and other code or settings stored in an onboard memory of a hardware component.

In addition, EC 513 may provide an Out-of-Band communication channel that allows an Information Technology Decision Maker (ITDM) or Original Equipment Manufacturer (OEM) to manage IHS 500’s various settings and configurations, for example, by issuing OOB commands.

In various embodiments, IHS 500 may be coupled to an external power source through an AC adapter, power brick, or the like. The AC adapter may be removably coupled to a battery charge controller to provide IHS 500 with a source of DC power provided by battery cells of a battery system in the form of a battery pack (e.g., a lithium ion or “Li-ion” battery pack, or a nickel metal hydride or “NiMH” battery pack including one or more rechargeable batteries). Battery Management Unit (BMU) 514 may be coupled to EC 513 and it may include, for example, an Analog Front End (AFE), storage (e.g., non-volatile memory), and a microcontroller. In some cases, BMU 514 may be configured to collect and store information, and to provide that information to other IHS components.

Examples of information collectible by BMU 514 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), events, etc. Examples of events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, IHS 500 may not include all the components shown in FIG. 5. Furthermore, some components that are represented as separate components in FIG. 5 may instead be integrated with other components, such that all or a portion of the operations executed by the illustrated components may instead be executed by the integrated component. For example, in various embodiments described herein, host processor(s) 501 and/or other components shown in FIG. 5 (e.g., chipset 502, display controller(s) 504, communication interface(s) 503, EC 513, etc.) may be replaced by other devices. As such, IHS 500 may assume different form factors including, but not limited to: servers, workstations, desktops, laptops, appliances, video game consoles, tablet computers, smartphones, etc.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A method, comprising:
receiving a request to replace a first motherboard in a device, the first motherboard having a first identifier, and the device having a service tag and a first ownership voucher;
designating a second motherboard to replace the first motherboard, the second motherboard having a second identifier;
requesting a voucher management system to link the second identifier to the service tag;
identifying the second ownership voucher using the second identifier;
creating an extended second ownership voucher with information from the first ownership voucher; and
linking the extended second ownership voucher to the first ownership voucher.

2. The method of claim 1, wherein the first and second identifiers are serial numbers.

3. The method of claim 1, wherein the information from the first ownership voucher comprises one or more of a device type, a service tag, and the first identifier.

4. The method of claim 1, wherein the extended second ownership voucher comprises the identity of a party requesting motherboard replacement and a first voucher management system signature.

5. The method of claim 1, further comprising:
transferring the extended second ownership voucher to a control plane with a second voucher management system signature.

6. The method of claim 1, further comprising:
linking, by a control plane, the extended second ownership voucher to the first voucher; and
registering the extended second ownership voucher with a rendezvous server.

7. The method of claim 6, further comprising:
receiving, at the control plane, an onboard request from the device; and
retrieving, at the control plane, the extended second ownership voucher to complete an onboarding process for the device.

8. The method of claim 7, wherein the extended second ownership voucher on the control plane comprises a universal identifier of the first voucher.

9. The method of claim 1, further comprising:
identifying a request to replace the first motherboard;
establishing a block against additional requests to replace the first motherboard;
determining that the second motherboard has replaced the first motherboards: and
removing the block as to allow additional requests to replace the first motherboard.

10. The method of claim 9, wherein the request to replace the first motherboard is identified by creating of the extended second ownership voucher.

11. An apparatus, comprising:
a processor; and
a memory coupled to the processor, the memory having program instructions stored thereon that, upon execution, cause the processor to:
boot the apparatus to a post-onboarding operating system;
identify that a current motherboard has changed from an original motherboard;
reboot the apparatus to a factory operating system;
initiate an onboarding process to a control plane; and
complete the onboarding process when the control plane has an ownership voucher associated with the current motherboard.

12. The apparatus of claim 11, wherein the program instructions further cause the processor to:
regenerate keys for a secure communication channel to the control plane;
reboot the apparatus to the post-onboarding operating system; and
connect the apparatus and control plane via the secure communication channel.

13. The apparatus of claim 11, wherein the program instructions further cause the processor to:
determine that a hard drive was replaced;
download a new copy of the post-onboarding operating system; and
boot the apparatus to the new copy of the post-onboarding operating system.

14. An apparatus, comprising:
a processor; and
a memory coupled to the processor, the memory having program instructions stored thereon that, upon execution, cause the processor to:
store a first ownership voucher associated with a first motherboard by a first serial number;
store a first ownership voucher, the first ownership voucher associated with a first motherboard by a first serial number;
store a second ownership voucher associated with a second motherboard by a first serial number;
extend the second ownership voucher with information from the first ownership voucher;
sign an extended second ownership voucher with a voucher management service signature; and
transfer the extended second ownership voucher to a control plane.

15. The apparatus of claim 14, wherein the first motherboard is installed in a device that has onboarded to the control plane; and wherein the second motherboard has been designated as a replacement for the first motherboard.

16. The apparatus of claim 14, wherein the extended second ownership voucher comprises the second serial number, a device type, a service tag, the first serial number, and an identifier for a party who requested a motherboard replacement.

17. The apparatus of claim 14, wherein the program instructions further cause the processor to:
link the extended second ownership voucher to the first ownership voucher.

18. The apparatus of claim 14, wherein the program instructions further cause the processor to:
extend the second ownership voucher upon receipt of a request to link the second serial number to a device service tag.

19. The apparatus of claim 14, wherein the program instructions further cause the processor to:
identifying a request to replace the first motherboard;
temporarily blocking additional requests to replace the first motherboard;
determining that the second motherboard has replaced the first motherboards: and
removing the block to allow additional requests to replace the first motherboard.

20. The apparatus of claim 19, wherein the temporary block of additional requests begins when a replacement motherboard is ordered, and wherein the block is removed when the replacement motherboard is installed.
